(19) United States
(12) Patent Application Publication
(10) Pub. No.: US 2026/0104579 A1
(43) Pub. Date: Apr. 16, 2026

(54) METHOD FOR MICROSCOPY IMAGING

(71) Applicant: Leica Microsystems CMS GmbH, Wetzlar (DE)

(72) Inventors: Frank HECHT, Wetzlar (DE); Daniel STRACKBEIN, Wetzlar (DE); Stefan WELTI, Wetzlar (DE)

(21) Appl. No.: 19/352,490

(22) Filed: Oct. 8, 2025

(30) Foreign Application Priority Data
Oct. 10, 2024 (DE) 102024129255.5

(51) Int. Cl. G02B 21/36; G01N 21/01; G01N 21/64; G06T 1/00

(52) U.S. Cl. CPC G02B 21/367; G01N 21/01; G01N 21/6458; G02B 21/368; G06T 1/0007; G01N 2021/0137; G06T 2200/24

(57) ABSTRACT

A method for preparing for microscopy imaging includes acquiring a plurality of images by a microscopy system and annotating each of the plurality of images with respective metadata concerning the microscopy system. The plurality of images are grouped such that images of the plurality of images at least partially sharing the metadata are grouped in a same group of images.

### CROSS REFERENCE TO RELATED APPLICATIONS

This application claims benefit to German Patent Application No. 10 2024 129 255.5, filed on Oct. 10, 2024, which is hereby incorporated by reference herein.

### FIELD

The invention relates to a method for preparing microscopy imaging, a method of microscopy imaging, a microscopy system, and a use of said system.

### BACKGROUND

Often, when preparing for microscopy imaging, a user captures microscope images with different hardware settings and compares the images with each other to find suitable hardware settings for further use.

Comparing the results of different settings is, however, time-consuming and/or error prone. In particular, this is the case if the settings need to be managed manually. For example, it is time-consuming to restore a previous setting from existing image data in order to be able to capture further images at the same setting. After the preparation, the actual microscope imaging is performed on the basis of suitable hardware settings, which hardware settings have been selected on the basis of the images taken.

### SUMMARY

In an embodiment, the present disclosure provides a method for preparing for microscopy imaging. The method includes acquiring a plurality of images by a microscopy system and annotating each of the plurality of images with respective metadata concerning the microscopy system, and grouping the plurality of images such that images of the plurality of images at least partially sharing the metadata are grouped in a same group of images.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a microscopy system of an embodiment of the invention.

FIG. 2 schematically shows a structure underlying a microscopy system of an embodiment of the invention.

FIG. 3(a) schematically shows a graphical user interface of a microscopy system of an embodiment of the invention.

FIG. 3(b) schematically shows a graphical user interface of a microscopy system of an embodiment of the invention.

### DETAILED DESCRIPTION

In an embodiment, the present invention provides for more reliable, fail-safe, and/or time-efficient handling of microscope images when preparing or planning microscope imaging and/or during processing of images by a method for preparing microscopy imaging. The method includes (1) acquiring a plurality of images by means of a microscopy system and annotating each of the plurality of images with respective metadata concerning the microscopy system, and (2) grouping the plurality of images such that images of the plurality of images at least partially sharing the metadata are grouped in a same group of images.

The metadata and the images are correlated with each other in that the images are grouped on the basis of the metadata, e.g. on a one-by-one basis per group and metadata. Grouping may mean to distribute the images among groups (more specifically each image in a single group), such that images having the same metadata in common are allocated to the same group. Hence, a group may be representative of specific metadata and comprises multiple images. Grouping may mean putting images sharing at least specific metadata in the same sub-category. Groups of images may be represented visually or non-visually.

In this regard, images of a same group have at least partially the same, optionally entirely the same metadata in common. Put differently, a group of images may be characterized by including images having at least in part, optionally entirely, the same metadata. The metadata may be the basis for defining different groups, each group representative of specific metadata. Metadata does not need to be completely different between groups, there may be an overlap between metadata characterizing different groups. Overlapping metadata between groups may e.g. relate to hardware components of the microscope, such as the light source and/or the detector, or other hardware settings, as described below.

Multiple groups may be provided, e.g. at least three groups, or at least five groups. The number of groups may vary, e.g. depending on the complexity of the metadata.

Metadata may be indicative of settings of the microscope, e.g. hardware settings of the microscope, such as specific settings, e.g. the excitation light intensity applied when capturing the image. Hence, the excitation light intensity with which an image is acquired may determine the attribution to a group, when the groups are characterized by a specific excitation light intensity.

Other parameters may include the wavelengths of the light sources, detection bands, lifetime settings, distribution of the different detection bands to more or fewer scan-passes during the acquisition of one image.

For fluorescent microscopy, a specific example hardware setting may comprise, e.g. detection bands (e.g. including beam route (a list of integer values), begin and/or end of the image acquisition, marker and name of . . . ), laser lines (e.g. including wavelength, beam route, index, intensity, relative intensity, name, shortname), and/or markers (dye, observed brightness, signature color, name and optionally some other user specific information like laboratory ID, date, comment, etc.). Accordingly, e.g. the marker/dye is part of a hardware setting.

An image is attributed to a (staining) group, if all parameters of the hardware setting correspond to the specific (staining) group.

Images may relate to the same sample, so that all groups also relate to the same sample to be imaged by the microscope.

The invention offers various improved embodiments. In some embodiments, errors may be reduced by grouping of images according to metadata, compared to non-grouped images. In particular, grouping on the basis of metadata may help to access images having the desired metadata, as a group “promises” the exclusion of images not having the specific metadata. Also, swift changing between different metadata, i.e. different groups, and respective images may be possible, as this may be done on the basis of changing between groups. Comparing images of a first group with images of a second group, i.e. comparing images of different groups, may be simplified by differentiating between first and second groups each defining an “umbrella” for the respective individual images per group.

Alternatively or additionally, embodiments of the invention may simplify comparing different metadata and corresponding images, e.g. hardware settings based on the corresponding images taken, with each other. For example, it may help to swiftly compare images characterized by different metadata with each other, as images sharing metadata are allocated to different groups, which may help a user to “find” images having different metadata.

Alternatively or additionally, this may allow for improved handling of images taken. For example, handling based on same metadata, e.g. same hardware settings, and corresponding visibility and visual presentation may be based on the groups as provided. Embodiments of the invention may support creation and evaluation of microscope settings (e.g. hardware settings) for subsequent use based on the metadata.

Otherwise, without an embodiment of the invention, the user may have to memorize which setting was used when an image was acquired. Specifically, it may not be possible to recognize, e.g. see, whether two images were captured with identical settings. If one wants to reuse settings, they may either need to be saved explicitly or reimported via existing image data. The administration of these settings may need to be done by the user and therefore manually. Evidently, with a large number of sample data, this may be prone to errors.

Optionally, the method includes adjusting the microscopy system according to metadata of an image of a group (into a microscope setting configuration) and taking/acquiring further images for optionally said group with said metadata, here with said microscope setting configuration. This may help to take, i.e. acquire, further images with the same hardware settings of a group. Specifically, after preparation, the actual microscope imaging is performed on the basis of suitable metadata, e.g. hardware settings, characteristic of one group, which metadata have been selected on the basis of the images taken. In particular, one group may be selected on the basis of the images allocated to this group as leading to e.g. the best image quality.

More optionally, the metadata is loaded, before the microscopy system is adjusted according to the metadata into the microscopy setting configuration. This may allow to adapt the microscope as to its configuration, in particular automatically. The microscopy setting configuration may relate to the focus, brightness of the light source, sensitivity of the sensors (scintillators, camera, semiconductor sensor such as Charge-Coupled Device (CCD) etc.).

Optionally, the microscopy setting configuration is adjusted by a user to a user adjusted microscopy setting configuration. In particular, a user may change and further adjust the microscope setting configuration, as e.g. automatically proposed.

Optionally, the microscopy setting configuration and/or the user adjusted microscopy setting configuration is/are adjusted based on microscope feedback, optionally provided by an optimization algorithm run on a microscopy system, more optionally for optimization of image quality, signal to noise ratio, and/or pixel saturation. Microscope feedback may relate to parameters such as light intensity, focus sharpness, sample contrast, temperature fluctuations, and/or drift in the sample stage. At least some or all may influence image quality and may be used to automatically adjust settings for optimal imaging performance.

Optionally, the method further includes adding a group of images to existing groups, if an image is not groupable into the existing groups. For example, when changing the hardware settings of the microscope, a further group is added so as to represent a group characterized by metadata reflective of the changed hardware settings.

Optionally, the method further includes that selecting a group, optionally an image of a group, entails indication of the remaining images of said group. For example, selecting a group or an image of a group leads to indicating the chronological order of the images taken.

Optionally, the method further includes that selecting a group entails indication of the images of said group. For example and more optionally, selecting a group may mean that the image history of images as taken is shown per group.

Optionally, the method further includes excluding images of a group from the remaining groups. For example, an automatic exclusion of images not belonging to the respective group may be performed, e.g. by not showing excluded images visually. This may in particular help to reduce errors, when only images sharing common metadata, e.g. hardware settings, are available.

Optionally, the method further includes that taking the plurality of images includes imaging samples stained by different fluorophores. This represents a preferred embodiment and application of the method of the invention. In other words, the method may be carried out for multicolor/multiplex microscopy and/or fluorescent microscopy. In this regard, an image may be characterized by a fluorophore with which the sample was stained. A group may include images of the sample stained with different fluorophores. Thus, a group may be characterized by images indicative of different stains/dyes, but same hardware settings, of a sample. For example, 15 different fluorophores may be used. This may be referred to as staining group.

One or more hardware settings may be attributed to a staining group. The hardware settings of each staining group are identical.

Optionally, the method includes storing the metadata in a memory (unit), such as a storage medium. This may allow to swiftly retrieve different metadata, when desired.

Optionally, the method includes reading the metadata of images, optionally of images acquired previously or imported, and optionally storing of the metadata, e.g. in the memory.

An embodiment of the invention includes a method of microscopy imaging, including the method of preparing microscopy imaging of an embodiment of the invention, further including processing images per group. This may relate to post-processing of the images, on the basis of a group. This may help to include only images sharing the specific metadata for (post)processing. Hence, the groups as created during preparation or planning of microscopy may be relevant for subsequent processing, as images are processed per group.

In an embodiment of the present disclosure, images of a group may be processed on the basis of metadata associated with said group. For example, the hardware settings may be relevant to resolving spectral mixing issues during post-processing. Thus, the hardware settings shared by a group may form the basis for processing the images of the respective group.

In an embodiment of the present disclosure, image processing of a group may involve corrections, such as spectral correction, based on metadata associated with the group. For instance, when processing images from fluorescent microscopy, signal crosstalk may be reduced. This correction may include using a linear matrix for unmixing images based on hardware settings. An example of this may be incorporating fluorescence lifetime properties of fluorophores. Another example is applying a correction based on fluorescence lifetime and the natural background (endogenous fluorescence). This may involve selecting detector signals based on photon arrival times using time gates or separating fluorescence components through FLIM (fluorescence lifetime imaging microscopy) decay fitting. Corrections may also include denoising and deconvolution, either in successive steps or combined with spectral or lifetime separation. Additionally or alternatively, a trained neural network may perform the correction using spectral and/or lifetime information from the acquired images. Metadata associated with the group may include parameters for these processing steps, such as the neural network model.

Optionally, the method includes acquiring an image on the basis of metadata, and saving the metadata of the image acquisition as annotation to the image and/or in the memory. This may allow to acquire an image without confirming or even knowing the microscope settings (i.e. the microscope setting configuration) at the time of the acquisition, as the metadata is stored in the image and/or memory and thus renders the metadata available after image acquisition.

Optionally, the method includes retrieving the metadata from the memory and modifying the retrieved metadata, and creating training data based on the modified retrieved metadata to obtain improved metadata. This may allow to obtain optimized metadata by way of training by means of training data.

An embodiment of the invention includes a microscopy system having a microscope and a computer, wherein the system is configured to carry out the steps for an embodiment of the method of the invention. Optionally, the computer includes a processor, which is further optionally configured to carry out at least some steps of an embodiment of the invention.

Optionally, the system is configured for fluorescent microscopy. In other words, the system may be configured for multicolor/multiplex microscopy.

Optionally, the system or the computer comprises a memory for storing metadata.

Optionally, the system further comprises a display device such as a monitor or another graphical user interface, optionally for visual output, more optionally output of the grouping.

Optionally, the system comprises a user interface for initiating indication of the metadata, optionally by means of a button comprised in the user interface. For example, the button may be pressed for a history function (e.g. to show all acquired images) and/or to obtain metadata.

Optionally, the user interface is configured for selecting options for adjustment of the metadata.

An embodiment of the invention includes fluorescent microscopy, wherein the use of the system comprises imaging samples stained by fluorophores at hardware settings of a microscope, and grouping samples stained by different fluorophores and same hardware settings in the same group. This may in particular be helpful to avoid errors in processing images in multicolor/multiplex microscopy.

Detailed embodiments and further advantages and features related to the present invention are described in the following, wherein these examples shall not be regarded as limiting the invention.

As used herein the term “and/or” includes any and all combinations of one or more of the associated listed items and may be abbreviated as “/”.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

At least a part of the method steps are performed by a computer, such as the grouping of the plurality of images. At least this step may be regarded as a computer-implemented step.

More generally, some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

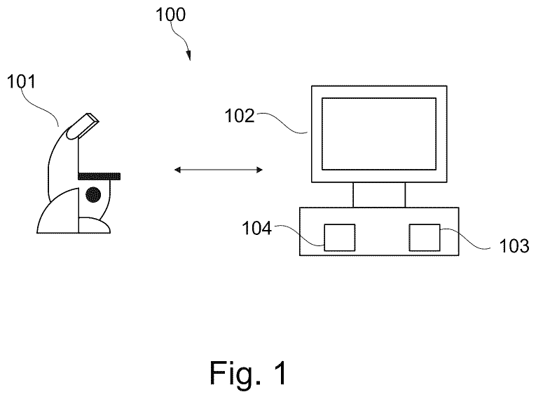

FIG. 1 schematically shows a microscopy system 100 including a computer (system) 102 and a microscope 101. The system 100 is, in this embodiment, configured for fluorescent microscopy, and may be a system for multicolor/multiplex microscopy.

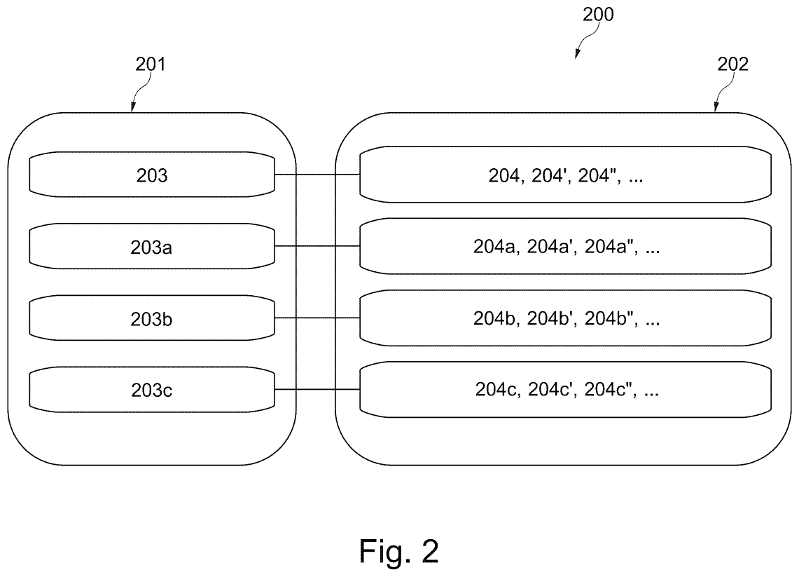

FIG. 2 schematically shows a structure 200 including metadata, here microscope settings 201, and corresponding grouped images 202 which have been acquired. The metadata 201 and the groups of images 202 are correlated with each other in that the images are grouped on the basis of the metadata 201. More generally, each metadata 202 is correlated with a single group of images 202.

Here, the metadata 201 may relate to microscope settings, specifically multiple, here four, different microscope (e.g. hardware) settings 203, 203a, 203b, 203c as indicated in FIG. 2. Also, FIG. 2 shows four different groups of images 202, namely a first group of at least images 204, 204′, 204″ characterized by common metadata 203; a second group of at least images 204a, 204a′, 204a″ characterized by common metadata 203a; a third group of at least images 204b, 204b′, 204b″ characterized by common metadata 203b; and a fourth group of at least images 204c, 204c′, 204c″ characterized by common metadata 203c. More or less images per group are possible.

The microscope settings 203, 203a, 203b, 203c may have parameters in common, such as relating to the light source and the detector, but differ as to specific parameters such as the intensity with which the images have been acquired. Hence, each of the first to fourth groups of images 202 are indicative of different intensities of the light, in this example.

Accordingly, if a user selects the image 204 of the first group defined by the hardware setting 203, the user may receive an indication of the remaining images 204′, 204″ of the first group. This may help the user to swiftly derive an assessment of the suitability of the hardware setting 203, for example, for which assessment all images 204, 204′ and 204″ are taken into account.

Alternatively, if a user selects the first group defined by the hardware setting 203, the user may receive an indication of all images 204, 204′, 204″ of the first group. This may help the user to swiftly derive an assessment of the suitability of the hardware setting 203, for example, for which assessment all images 204, 204′ and 204″ are taken into account.

The grouping according to metadata 201 helps the user to handle the various images. For example, the user is assisted with the assessment in that all images 204, 204′ and 204″ of the first group are excluded, when the user analyses e.g. the second group, defined by the setting 203a and the corresponding images 204a, 204a′, 204a″.

The structure 200 may be created by acquiring images by means of the microscopy system 100 and annotating each of the plurality of images 204, . . . , 204a, . . . 204b, . . . 204c, . . . with respective metadata 203, 203a, 203b, 203c concerning the microscopy system 100. Subsequently, the plurality of images is grouped such that images 204, 204′, 204″ of the plurality of images sharing hardware settings 203 are grouped in the same group of images. This is done until all images have been grouped according to the metadata 201. A group of images may be added to existing groups, if an image is not groupable into the existing groups.

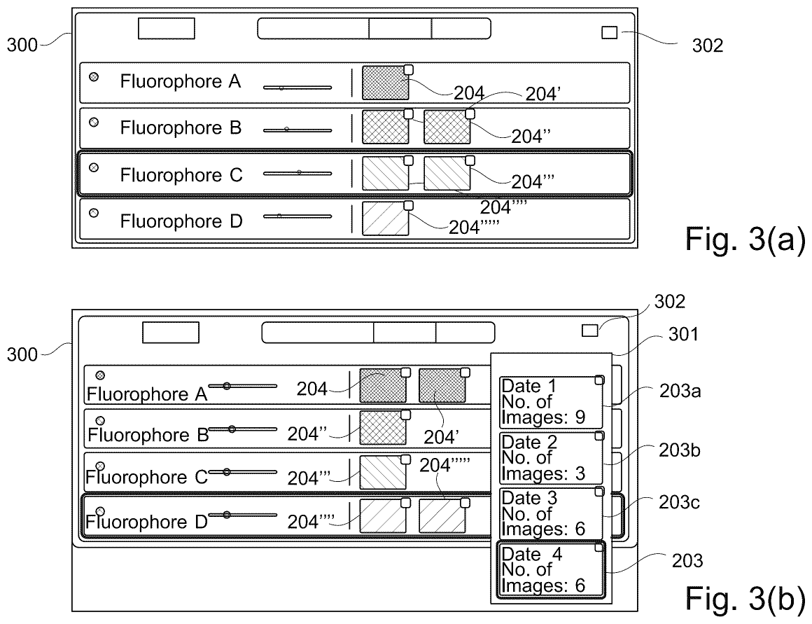

FIG. 3(a) and 3(b) schematically show metadata and images relating to fluorescent microscopy, more specifically stained samples represented on a graphical user interface 300. Hence, FIG. 3(a) and (b) show a specific application of an embodiment of the present invention for spectral mixing in fluorescent microscopy, for fluorophores A, B, C, and D. In this case, the plurality of images has been taken by imaging a sample stained by the different fluorophores A to D. Accordingly, the sample may be stained by the different fluorophores, and imaged at same or different hardware settings of the microscope 101. The sample as stained by different fluorophores at the same hardware settings is shown in the graphical user interface 300.

For preparation of the samples/specimens, staining protocols, antibodies, and other parameters are defined.

Based on a list of markers (as selected by the user) and the speed as selected by the user for performing the experiment, a set of hardware settings is created. For example, higher speed implies a reduced number of differential setting and, thus, higher crosstalk during image acquisition. Also, staining groups representing groups pertaining to the dyes as used are determined. These staining groups are generated by a computer, using algorithms for determining an appropriate (optimized) distribution for the desired setting.

Each staining group has one or more hardware settings. An acquired image is annotated with the hardware setting (i.e. metadata) used for image acquisition. An image is attributed to a staining group, i.e. grouped, based on the hardware setting, which is identical for images corresponding to the same hardware setting.

In an example, the metadata is loaded, before the microscopy system 100 is adjusted according to the metadata into the microscopy setting configuration. The microscopy setting configuration may relate to the focus, brightness of the light source, sensitivity of the sensors (scintillators, camera, semiconductor sensor such as CCD etc.) or other entities. The user may adjust the microscopy setting configuration and for example change and further adjust the microscope setting configuration.

The microscopy setting configuration and/or the user adjusted microscopy setting configuration is/are adjusted based on microscope feedback, optionally provided by an optimization algorithm run on a microscopy system 100, more optionally for optimization of image quality, signal to noise ratio, and/or pixel saturation. Such feedback may relate to one or more parameters such as light intensity, focus sharpness, sample contrast, temperature fluctuations, and/or drift in the sample stage.

More specifically, FIG. 3(a) and 3(b) schematically show the graphical user interface 300 for presentation of the groupings. All images 204, . . . 204″″′ acquired with a specific, same hardware setting 203 are summarized in a general overview. This can be filtered according to various criteria.

Specifically, light sources and detectors are the same in the images of FIG. 3(a) and 3(b). Other acquisition settings which are not relevant for the processing may differ.

The hardware setting contains all information to record a sample stained with a given set of fluorophores (e.g. 15). Each fluorophore is recorded by at least one detection band (channel) and excited with light of a defined wavelength. Each detection band will yield one pixel image; the ‘recorded image’ is therefore a group of pixel images. Since the microscope has a maximum of 5 detection units, not all 15 fluorophores can be recorded within one scan-pass, so multiple scan-passes might be necessary. It is possible to use these hardware settings to record samples that are stained with only a subset of fluorophores, e.g. 1 out of 15. The resulting ‘recorded image’ still consists of 15 pixel images (channels), with few (ideally one) containing signal. In FIG. 3(a) and 3(b), each row corresponds to a sample stained with dye A, B, C . . . only, but all are still recorded with the same hardware setting that is addressing all 15 dyes (A, B, C, . . . “15”).

The metadata 201 is stored in a memory (unit), such as a storage medium 104. The metadata 201 of images, optionally of images acquired previously or imported, is read and stored in the memory 104.

An image may be acquired on the basis of metadata 201, and the metadata of the image acquisition is saved/stored as annotation to the image and/or in the memory 104. This may allow to acquire an image without confirming or even knowing the microscope settings (i.e. the microscope setting configuration) at the time of the acquisition, as the metadata 201 is stored in the image and/or memory and thus renders the metadata available after image acquisition.

The metadata 201 may be retrieved from the memory 104 and the retrieved metadata may be modified, thus the system or the computer comprises a memory for storing metadata.

The system 100 or the computer system 102 comprises a memory 104 for storing metadata and a processor 103 to carry out at least some of the steps of an embodiment for a method of the invention.

The system 100 comprises a display device such as a monitor or another graphical user interface 300 for visual output of the grouping, e.g. groups of images 202 and metadata 201.

The system comprises the user interface 300 for initiating indication of the metadata 201, optionally by means of a button 302 comprised in the user interface 300. For example, the button 302 may be pressed for a history function (e.g. to show all acquired images) and/or to obtain metadata 201.

The user interface 300 is configured for selecting options for adjustment of the metadata 201, e.g. of the hardware settings.

The system 100 allows for creating training data based on the modified retrieved metadata to obtain improved metadata. This may allow to obtain optimized metadata by way of training by means of training data.

Via a history list 301, as shown in FIG. 3(b), one may switch between all hardware settings 203,a, b, c for which image data is available and thus provide a quick way to evaluate the hardware settings 203,a, b, c with each other. In the example shown in FIG. 3(b), the setting 203 has been selected, wherein the settings 203a, b, c are not selected. Accordingly, only the images 204, 204′, 204″, . . . of the group correlated with the setting 203 are shown in the graphical user interface 300, for each fluorophores A to D, at different intensities, as indicated by the register per fluorophore. The four intensities belong to one, i.e. same, hardware setting. Changing one of these intensities would imply a different hardware setting.

Images are grouped in the underlying data model according to the metadata 201, e.g. hardware settings, with which the images were captured. Hence, the user interface 300 shows the images as currently acquired and helps to simplify handling/administration of the captured images.

All images that match the hardware settings e.g. 203 currently set in the microscope 101 are displayed in an overview graphical representation on the interface 300. All images shown are annotated with identical hardware settings, which correspond to the hardware settings for current image acquisition. If hardware settings are changed at the microscope, it is checked for images that are annotated with the changed setting, and, if so, such images with the changed hardware setting are shown on the user interface. The images with the previous hardware settings are not shown on the user interface (but hidden).

By selecting an image, one may view and evaluate the specific image in the viewer. The history list 301 may provide an overview of all existing hardware settings 203, 203a, 203b, 203c and the groups of images 202 that have been captured with them. An entry may contain information on when images were acquired e.g. date, and/or when the first and last image in the group was taken. By selecting an entry in the history dialogue/list 301, the hardware setting 203 used is set in the microscope 101 and the corresponding images 204, 204′, 204″ are displayed in the overview. This allows the user to quickly switch between different settings and makes it easier to capture new images with existing hardware settings. For example, the microscope 101 is adjusted according to metadata 201 of an image of a group 202 and further images for said group with said metadata are acquired.

Which or how many staining groups are shown on the graphical interface 300 may depend on the unmixing strategy. For example, for each marker, a staining group is defined. Alternatively, similar markers may be summarized in a staining group. Further alternatively, only a single staining group is defined, which includes all markers.

It also makes it easier to evaluate the respective metadata 201 using the associated images of a group 202.

Subsequent to preparing/planning and acquiring the images, images are processed per group. More specifically, images of a group 203 are on the basis of metadata 201 associated with said group, processed. As the group may be reflective of fluorescent imaging, processing of the images includes reduction of fluorescent-related issues. More specifically, processing images of a group includes a correction, optionally a spectral correction, based on the metadata 201 associated with said group 202. With reference to FIG. 3(a) and 3(b) and fluorescent microscopy, the correction may include a linear matrix for unmixing of images based on a group of images 202, i.e. on metadata 201, in connection with the fluorophores. Here, it is specifically helpful to reply on the groups 202 so as to avoid mistakes in processing, e.g. such as including a “wrong” image in the processing step.

Another example is a correction based on fluorescence lifetime properties of fluorophores, more specifically a correction based on fluorescence lifetime and the natural background (endogenous fluorescence). This may involve selecting detector signals based on photon arrival times using time gates or separating fluorescence components through FLIM (fluorescence lifetime imaging microscopy) decay fitting. Corrections may alternatively or additionally include denoising and deconvolution, either in successive steps or combined with spectral or lifetime separation. Additionally or alternatively, a trained neural network may perform the correction using spectral and/or lifetime information from the acquired images.

Metadata associated with the group may include parameters for these processing steps, such as the neural network model.

Some embodiments relate to a microscope 101 comprised in a system as described in connection with FIG. 1. Alternatively, a microscope 101 may be part of or connected to a system 100 as described in connection with FIG. 1. FIG. 1 shows a schematic illustration of a system 100 configured to perform a method described herein. The system 100 comprises a microscope 101 and a computer system 102. The microscope 101 is configured to take images and is connected to the computer system 102. The computer system 102 is configured to execute at least a part of a method described herein. The computer system 102 and microscope 101 may be separate entities but can also be integrated together in one common housing. The computer system 102 may be part of a central processing system of the microscope 101 and/or the computer system 102 may be part of a subcomponent of the microscope 101, such as a sensor, an actor, a camera or an illumination unit, etc. of the microscope 101.

The computer system 102 may be a local computer device (e.g. personal computer, laptop, tablet computer or mobile phone) with one or more processors and one or more storage devices or may be a distributed computer system (e.g. a cloud computing system with one or more processors and one or more storage devices distributed at various locations, for example, at a local client and/or one or more remote server farms and/or data centers). The computer system 102 may comprise any circuit or combination of circuits. In one embodiment, the computer system 102 may include one or more processors which can be of any type. As used herein, processor may mean any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, a field programmable gate array (FPGA), for example, of a microscope or a microscope component (e.g. camera) or any other type of processor or processing circuit. Other types of circuits that may be included in the computer system X20 may be a custom circuit, an application-specific integrated circuit (ASlC), or the like, such as, for example, one or more circuits (such as a communication circuit) for use in wireless devices like mobile telephones, tablet computers, laptop computers, two-way radios, and similar electronic systems. The computer system 102 may include one or more storage devices, which may include one or more memory elements suitable to the particular application, such as a main memory in the form of random access memory (RAM), one or more hard drives, and/or one or more drives that handle removable media such as compact disks (CD), flash memory cards, digital video disk (DVD), and the like. The computer system 102 may also include a display device, one or more speakers, and a keyboard and/or controller, which can include a mouse, trackball, touch screen, voice-recognition device, or any other device that permits a system user to input information into and receive information from the computer system 102.

The detailed description of the invention is provided with respect to the embodiments depicted in the drawings. Obvious variations and alternatives may occur to the skilled person, based on the present disclosure.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### List of Reference Signs

100 microscopy system
101 microscope
102 computer system
103 processor
104 memory
200 structure
201 metadata
202 group of images
203, 203a, 203b, 203c hardware settings
204/′/″, 204a/′/″, images
204b/′/″, 204c/′/″
300 graphical user interface
301 history list
302 button

1. A method for preparing microscopy imaging, the method comprising:
acquiring a plurality of images by a microscopy system and annotating each of the plurality of images with respective metadata concerning the microscopy system; and
grouping the plurality of images such that images of the plurality of images at least partially sharing the metadata are grouped in a same group of images.

2. The method of claim 1, further comprising:
adjusting the microscopy system according to metadata of an image of a group into a microscopy setting configuration and acquiring further images for the group with the microscopy setting configuration.

3. The method of claim 2, wherein the metadata is loaded, before the microscopy system is adjusted according to the metadata into the microscopy setting configuration.

4. The method of claim 2, wherein the microscopy setting configuration is adjusted by a user to a user adjusted microscopy setting configuration.

5. The method of claim 4, wherein the microscopy setting configuration is adjusted based on microscope feedback provided by an optimization algorithm run on the microscopy system for optimization of image quality, signal to noise ratio, and/or pixel saturation.

6. The method of claim 1, further comprising:
adding a group of images to existing groups, if an image is not groupable into the existing groups.

7. The method of claim 1, further comprising:
selecting an image of a group entails indication of remaining images of the group.

8. The method of claim 1, further comprising:
selecting a group entails indication of the images of the group.

9. The method of claim 1, further comprising:
excluding images of a group from remaining groups.

10. The method of claim 1, wherein
acquiring the plurality of images includes imaging a sample stained by different fluorophores.

11. The method of claim 1, further comprising:
storing the metadata in a memory.

12. The method of claim 1, further comprising:
reading metadata of images that were acquired previously or imported, and storing the metadata of the images that were acquired previously or imported.

13. The method of claim 1, further comprising:
processing the images per group.

14. The method of claim 13, further comprising:
processing the images of a group on the basis of the metadata associated with the group.

15. The method of claim 14, wherein processing the images of the group includes a correction based on the metadata associated with the group.

16. The method of claim 13, further comprising:
acquiring an image on the basis of metadata, and saving the metadata of the image acquisition as annotation to the image and/or in memory.

17. The method of claim 16, further comprising:
retrieving the metadata from the memory and modifying the retrieved metadata, and creating training data based on the modified retrieved metadata to obtain improved metadata.

18. A microscopy system comprising a computer, a microscope, and a processor that is configured to carry out the steps of the method of claim 1.

19. The microscopy system of claim 18, wherein the microscopy system is configured for fluorescent microscopy.

20. The microscopy system of claim 18, further comprising a memory for storing metadata.

21. The microscopy system of claim 18, further comprising a display device for visual output of the grouping of the plurality of images.

22. The microscopy system of claim 18, further comprising a user interface for initiating indication of the metadata via a button comprised in the user interface.

23. The microscopy system of claim 22, wherein the user interface is configured for selecting options for adjustment of the metadata.

24. A method of using the microscopy system of claim 18 for fluorescent microscopy, the method comprising:
imaging samples stained by fluorophores at hardware settings of a microscope; and
grouping the samples stained by different fluorophores and same hardware settings in a same group.
